(19) United States
(12) Patent Application Publication
(10) Pub. No.: US 2026/0217908 A1
(43) Pub. Date: Jul. 30, 2026

(54) INDICATORS TO INDICATE THE DEGREE OF DEPOLYMERISATION

(71) Applicant: B4PLASTICS BV, Dilsen-Stokkem (BE)

(72) Inventors: Veerle ROYEN, Overrepen (BE); Tom GHEYSENS, Asper (BE); Stefaan DE WILDEMAN, Maasmechelen (BE); Kristièn VAN TILBURG, Maastricht (NL)

(21) Appl. No.: 19/159,058

(22) PCT Filed: Feb. 23, 2024
(86) PCT No.: PCT/EP2024/054596

§ 371 Date: Aug. 22, 2025

(30) Foreign Application Priority Data
Feb. 23, 2023 (EP) 23158121.6

(51) Int. Cl. C08G 63/91; C08K 3/22; C08K 3/26; C08K 5/46; G01N 31/22

(52) U.S. Cl. CPC C08G 63/912; C08K 3/22; C08K 3/26; C08K 5/46; G01N 31/22; G01N 31/221; C08K 2003/262

(57) ABSTRACT

The invention provides in the use of an indicator, to indicate the degree of depolymerisation, preferably the degree of biodegradation, of a degradable polymer in a polymer composition or an article made from said polymer composition. The invention further provides in a polymer composition comprising an indicator to indicate the degree of depolymerisation, and a method to visualise the degree of depolymerisation.

### FIELD OF THE INVENTION

The present invention relates to the technical field of polymer compositions and articles made from said polymer composition. More particularly, the invention relates to degradable and biodegradable polymer compositions and provides ways to indicate the state of the depolymerisation of such polymer compositions.

### BACKGROUND OF THE INVENTION

Biodegradable polymers are an answer to many of the current environmental problems caused by pollution and waste management. In recent years, many biodegradable successful alternatives have been developed for the replacement of non-degradable polymers and articles. However, the success of these biodegradable alternatives largely depends on the state of degradation, or in other words the degree of depolymerisation of the biodegradable polymer. For a consumer, determining the state of degradation or depolymerisation can be very difficult or even impossible without the specialised equipment. For example an article made from a biodegradable polymer can appear to be in the right order, but biodegradation can already have started, for example due to improper storage in moist conditions or simply by age. Although visually intact, the polymer chains inside the article may have started to breakdown, weakening the integrity of the article or limiting the time a consumer can store the article themselves.

Hence, there is a demand for ways to indicate to a user or consumer the state of degradation or the degree of depolymerisation. Preferably, these ways do not require any instrumentation to determine the state of degradation or the degree of depolymerisation. Preferably, does the article already comprise all the required compounds to determine the state of degradation or the degree of depolymerisation, so that the user or consumer does not need to add any chemicals when determining the state of degradation or the degree of depolymerisation. Preferably, do these ways to determine the state of degradation or the degree of depolymerisation, not turn the article harmful or toxic.

Preferably, are any compounds added to the articles all biological based, and preferably biodegradable.

### SUMMARY OF THE INVENTION

It has now surprisingly been found that some or all of the above demands and objectives can be attained either individually or in any combination by using an indicator in the polymer composition further comprising a degradable polymer;
preferably, wherein the polymer composition comprises a base, a buffering agent or a mixture of thereof; and/or,
preferably, wherein the indicator is chemically incorporated, preferably copolymerised, in the polymer composition, and more preferably chemically incorporated in the degradable polymer.

In particular, in an aspect, the present invention relates to the use of an indicator, to indicate the degree of depolymerisation, preferably the degree of biodegradation, of a degradable polymer in a polymer composition or an article made from said polymer composition, preferably wherein appearance change of the indicator is caused by the depolymerisation of the degradable polymer.

More particular, the invention provides in use of an indicator, to indicate the degree of depolymerisation, preferably the degree of biodegradation, of a degradable polymer in a polymer composition or an article made from said polymer composition, preferably wherein appearance change of the indicator is caused by the depolymerisation of the degradable polymer;
wherein the indicator is chemically incorporated, preferably copolymerised, in the polymer composition, and more preferably chemically incorporated in the degradable polymer.

In an aspect, the invention relates to a polymer composition or an article comprising said polymer composition, wherein the polymer composition comprises:
at least 0.01 wt. % to at most 10.00 wt. % of an indicator, indicating the degree of depolymerisation, preferably the degree of biodegradation;
at least 0.05 wt. % to a most 25.00 wt. % of a base, a buffering agent or a mixture of thereof; and,
at least 65.00 wt. % to at most 99.94 wt. % of a degradable polymer.

In some embodiments, the polymer composition comprises at least 0.05 wt. % to a most 25.00 wt. % of a base.

In some embodiments, the base is selected from the list comprising NaOH, KOH, Ca(OH)₂, CsOH, RbOH, Mg(OH)₂, LiOH, Sr(OH)₂, Br(OH)₂, Na₂CO₃, NaHCO₃, NH₄OH, urea, histamine, or mixtures thereof, preferably selected from the list comprising NaOH Na₂CO₃, NaHCO₃, NH₄OH, urea, histamine or mixtures thereof.

In some embodiments, the base is an inorganic base.

In some embodiments, said indicator is a chromatic indicator.

In some embodiments, the indicator is a pH indicator, a complexometric indicator, a redox indicator, a temperature indicator or a hydrolysis indicator.

In some embodiments, the indicator is chemically blended or physically blended in the polymer composition.

In some embodiments, the indicator is chemically incorporated, preferably copolymerised, in the polymer composition and more preferably in the degradable polymer.

In some embodiments, the indicator is a halochromic indicator or an ionochromic indicator, preferably a halochromic indicator.

In some embodiments, the degradable polymer is a biodegradable polymer, preferably a home-compostable polymer.

In some embodiments, the polymer is a polycondensation polymer, preferably a polyester, a polyamide, a polyimide, a polyacetal, a polyurethane, a polycarbonate, or mixtures thereof; preferably the polymer is a polyester.

In some embodiments, the indicator is responsive to changes in concentrations of protons, in the polymer composition or the article made from said polymer composition.

In some embodiments, the indicator is a natural or a synthetic indicator, preferably selected from the list comprising cresol red, methyl red, bromocresol purple, bromocresol green, chlorophenol, resazurin, bromothymol blue, xylenol, curcumin, alizarin, shikonin, betalain, flavonoid and anthocyanin or combinations thereof, or derivatives thereof, preferably co-polymerizable derivatives thereof.

In some embodiments, the colour transition range of the indicator is below a pH of 7.00, preferably below a pH of 6.50, preferably below a pH of 6.00, preferably below a pH of 5.50.

In some embodiments, the pKa of the base, and/or the buffer agent is higher than the colour transition range of the indicator.

In some embodiments, the indicator is responsive to changes in concentration of ions, temperature, redox potential, and/or hydrolytic conditions.

In some embodiments, the polymer composition or an article comprising said polymer composition, wherein the polymer composition comprises:
at least 0.01 wt. % to at most 10.00 wt. % of an indicator, indicating the degree of depolymerisation, preferably the degree of biodegradation;
at least 0.05 wt. % to a most 25.00 wt. % of a base, a buffering agent or a mixture thereof; and,
at least 65.00 wt. % to at most 99.94 wt. % of a degradable polymer.

In some embodiments, the polymer composition or an article comprising said polymer composition, wherein the polymer composition comprises:
1 at least 0.01 wt. % to at most 10.00 wt. % of an indicator, indicating the degree of depolymerisation, preferably the degree of biodegradation;
at least 0.05 wt. % to a most 25.00 wt. % of a buffering agent; and,
at least 65.00 wt. % to at most 99.94 wt. % of a degradable polymer.

The invention provides further in a method for visualizing depolymerisation in a polymer composition or an article comprising the polymer composition; comprising the steps of:
incorporating an indicator in the polymer composition;
optionally, forming the article from the polymer composition.

More particular, the invention provides in a method for visualizing depolymerisation in a polymer composition or an article comprising the polymer composition; comprising the steps of:
incorporating an indicator in the polymer composition, preferably in an amount from at least 0.01 wt. % to at most 10.00 wt. % compared to the total weight of the polymer composition;
incorporating a base, a buffer agent, or a mixture of thereof in the polymer composition, preferably in an amount from at least 0.05 wt. % to a most 25.00 wt. % compared to the total weight of the polymer composition;
optionally, forming the article from the polymer composition.

In some embodiments, the base, the buffering agent, or the mixture thereof are incorporated in the polymer composition by chemically blending or physically blending, preferably by extrusion.

The invention provides further in a self-indicating degradable polymer, wherein an indicator is chemically incorporated in or to a degradable polymer, preferably a biodegradable polymer.

In some embodiments of the self-indicating degradable polymer the indicator is a hydrolysis indicator and wherein the degradable polymer is a poly-condensate, preferably a polyester or a polyamide, more preferably a polyester.

The independent and dependent claims set out particular and preferred features of the invention.

Features from the dependent claims may be combined with features of the independent or other dependent claims as appropriate.

The present invention will now be further described. In the following passages, different aspects of the invention are defined in more detail. Each aspect so defined may be combined with any other aspect or aspects unless clearly indicated to the contrary. In particular, any feature or statement indicated as being preferred or advantageous may be combined with any other features or statements indicated as being preferred or advantageous.

### BRIEF DESCRIPTION OF THE FIGURES

FIG. 1 represent some possible reaction schemes for the incorporation of indicators in degradable polymers.

FIG. 2 shows the results of enzymatic digestion of articles according to an embodiment of the invention.

### DETAILED DESCRIPTION OF THE INVENTION

When describing the invention, the terms used are to be construed in accordance with the following definitions, unless a context dictates otherwise.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

In the following passages, different aspects of the invention are defined in more detail. Each aspect so defined may be combined with any other aspect or aspects unless clearly indicated to the contrary.

In particular, any feature indicated as being preferred or advantageous may be combined with any other feature or features indicated as being preferred or advantageous.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims and statements, any one of the embodiments can be used in any combination.

The terms “comprising”, “comprises” and “comprised of” as used herein are synonymous with “including”, “includes” or “containing”, “contains”, and are inclusive or open-ended and do not exclude additional, non-recited members, elements, or method steps. It will be appreciated that the terms “comprising”, “comprises” and “comprised of” as used herein comprise the terms “consisting of”, “consists” and “consists of”.

As used in the specification and the appended claims, the singular forms “a”, “an,” and “the” include plural referents unless the context clearly dictates otherwise. By way of example, “a step” means one step or more than one step.

Unless defined otherwise, all technical and scientific terms used herein have the same meaning as is commonly understood by one of skill in the art.

The recitation of numerical ranges by endpoints includes all integer numbers and, where appropriate, fractions subsumed within that range (e.g., 1 to 5 can include 1, 2, 3, 4 when referring to, for example, a number of elements, and can also include 1.5, 2, 2.75 and 3.80, when referring to, for example, measurements). The recitation of endpoints also includes the end point values themselves (e.g., from 1.0 to 5.0 includes both 1.0 and 5.0). Any numerical range recited herein is intended to include all sub-ranges subsumed therein.

The term “about” as used herein when referring to a measurable value such as a parameter, an amount, a temporal duration, and the like, is meant to encompass variations of +/−10% or less, preferably +/−5% or less, more preferably +/−1% or less, of and from the specified value, insofar such variations are appropriate to perform in the disclosed invention. It is to be understood that the value to which the modifier “about” refers is itself also specifically, and preferably, disclosed.

The terms “wt %”, “vol %”, or “mol %” refers to a weight percentage of a component, a volume percentage of a component, or molar percentage of a component, respectively, based on the total weight, the total volume of material, or total moles, that includes the component.

When describing the present invention, the terms used are to be construed in accordance with the following definitions, unless a context dictates otherwise.

The present invention is based on the surprising finding that an indicator can be used to indicate the degree of depolymerisation of a degradable polymer in a polymer composition or an article made from said polymer composition. This indication of the degree of polymerisation can for example be used to indicate the state of biodegradation of the polymer composition or an article made from said polymer composition. The information of the degree of depolymerisation can then be used for an end-user to judge the quality of article made from the polymer composition, or to judge if biodegradation already set in or not.

As used herein, the term “depolymerisation” is preferably understood as the shortening of the chain length of a polymer, which may be due to the loss of monomer units or the cleavage of the polymer backbone, through chemical or enzymatic reaction.

In an aspect, the invention provides in the use of an indicator, preferably an indicator capable of undergoing a change in appearance under the influence of an external factor, to indicate the degree of depolymerisation, preferably the degree of biodegradation, of a degradable polymer in a polymer composition or an article made from said polymer composition, preferably wherein change in appearance of the indicator is caused by the depolymerisation of the degradable polymer.

More particular, the invention provides in use of an indicator, to indicate the degree of depolymerisation, preferably the degree of biodegradation, of a degradable polymer in a polymer composition or an article made from said polymer composition, preferably wherein appearance change of the indicator is caused by the depolymerisation of the degradable polymer; wherein the indicator is chemically incorporated, preferably copolymerised, in the polymer composition, and more preferably chemically incorporated in the degradable polymer.

In an aspect, the invention relates to a polymer composition or an article comprising said polymer composition, wherein the polymer composition comprises:
at least 0.01 wt. % to at most 10.00 wt. % of an indicator, indicating the degree of depolymerisation, preferably the degree of biodegradation;
at least 0.05 wt. % to a most 25.00 wt. % of a base, a buffering agent or a mixture of thereof; and,
at least 65.00 wt. % to at most 99.94 wt. % of a degradable polymer.

As used herein, the term “indicator” refers to a chemical compound that, often reversible, changes appearance:
upon presence or absence of a threshold concentration, or equivalence point of an external factor, preferably, the external factor is an analyte, such as protons; or,
upon chemical transformation of the indicator under the influence of an external factor, preferably the external factor can be hydrolysis conditions, as a lipase or a hydrolase. Preferably, the chemical transformation is the hydrolysis of a condensation linkage, preferably an ester group, present in the compound or the backbone of the compound.

Preferably, the change in appearance is a change in colour, preferably a change in wavelength of the reflected light beam. Preferably, the change in appearance manifests itself over a narrow concentration range of the external factor, around the threshold concentration or equivalence point. In some embodiments, the degradable polymer is a biodegradable polymer; preferably an industrial biodegradable polymer, marine degradable polymer and/or a home compostable polymer, preferably an industrial biodegradable polymer and/or a home compostable polymer, preferably a home-compostable polymer.

As used herein, the term “industrial biodegradable polymer” is for instance preferably understood as a polymer according to the European Standard EN 134323:2000.

As used herein, the term “home compostable polymer” is preferably understood as a polymer according to the French Standard NF T 51-800:2015.

As used herein, the term “marine compostable polymer” is preferably understood as a polymer according to ISO 22403:2020.

In some embodiments, the degradable polymer is selected from the list comprising polylactic acid (PLA), Polybutylene succinate (PBS), Polybutylene succinate terephthalate (PBST), Polybutylene adipate terephthalate (PBAT), Polycaprolactone (PCL), Polyhydroxyalkanoate (PHA), Polypropylene carbonate (PPC) or mixtures thereof.

The terms “PLA”, “polylactide polymer”, and “polylactic acid” are synonyms, and can be represented by structure (I). A “PLA” as used herein refers to a polymer of lactide (monomers). Lactide can exist in three different geometric structures, which have a diastereomeric relationship. The term “lactide” (or “lactide monomer”) as used herein may therefore be L-lactide (derived from two L-lactic acid molecules), D-lactide (derived from two D-lactic acid molecules), meso-lactide (derived from a L-lactic acid molecule and a D-lactic acid molecule), or a mixture of two or more of the above. A 50/50 mixture of L-lactide and D-lactide with a melting point of about 126° C. is often referred to in the literature as D,L-lactide or racemic lactide (and is also denoted as “rac-Lactide” or “racemic lactide” or “rac-lactide” herein). A PLA polymer as defined herein may thus be a polymer of lactide (monomer) selected from the group comprising L-lactide, D-lactide, meso-lactide, racemic lactide and any mixture of two or more thereof.

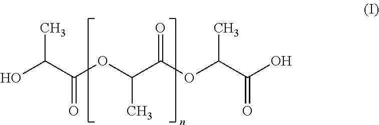

Polybutylene succinate (PBS), as defined herein, refers to a polymer that may be classified as a polyester, more preferably an aliphatic polyester, and most preferably a biodegradable aliphatic polyester. Polybutylene succinate comprises of repeating units of butylene succinate and can be represented by structure (II):

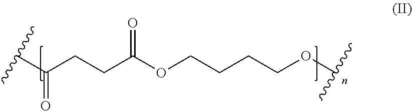

In the art, various ways of producing polybutylene succinate are known. In some embodiments, the process for producing PBS involves the esterification of succinic acid with 1,4-butanediol with the elimination of water, to form oligomers, which is followed by a trans-esterification under vacuum in the presence of a catalyst such as titanium, zirconium, tin, or germanium derivatives, to provide high molecular mass polymer. A skilled person will know Mutatis mutandis how to prepare PES, PPS, PBA, and PBSA.

Polybutylene succinate terephthalate (PBST), also known as poly(butylene succinate-co-butylene terephthalate), as defined herein, refers to a polyester comprising butylene succinate units and butylene terephthalate units.

Polybutylene adipate terephthalate (PBAT), as defined herein, refers to a biodegradable random copolymer, specifically a co-polyester of adipic acid, 1,4-butanediol and dimethyl terephthalate as represented in structure (III).

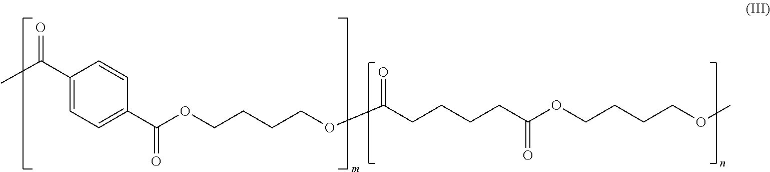

Polycaprolactone (PCL), as defined herein, refers to a polymer that can be obtained by polymerization of caprolactone, more preferably ε-caprolactone. Preferably, the polymerization can be carried out via ring opening polymerization, more preferably anionic ring opening polymerization. The polymerization may be carried out in the presence of an initiator and/or a catalyst. Both suitable initiators and catalyst are known in the art. Examples of suitable initiators are nucleophilic reagents, such as metal amides, alkoxides, phosphines, amines, alcohols, water or organometals, e.g., alkyl lithium, alkyl magnesium bromide, alkyl aluminium, etc. Examples of suitable catalysts are stannous (II) 2-ethylhexanoate a.k.a. stannous octoate or [Sn(Oct)₂], aluminium tri-isopropoxide, lanthanide isopropoxide.

Polycaprolactone can comprise structure (IV) as repeating motif, with the end groups depending on the used initiator and/or catalyst.

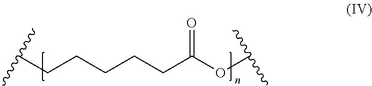

Polyhydroxyalkanoate (PHA), as defined herein, refers to a polymer that may be classified as a polyester, preferably a linear polyester. Polyhydroxyalkanoate may be produced by bacterial fermentation of lipids and sugar, such as glucose. In some embodiments, the polyhydroxyalkanoate may be produced biosynthetically. In some embodiments, the polyhydroxyalkanoate is biodegradable. Polypropylene carbonate (PPC), as defined herein, refers to a copolymer of carbon dioxide and propylene oxide. The polymer is thermoplastic and is typically formed by using zinc glutarate as catalyst during polymerization. The repeating motif of PPC may be represented by structure (V):

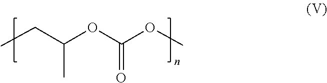

In some embodiments, said indicator is a chromatic indicator. This has the advantage that a consumer or user of the polymer composition or article can use his vision to judge the degree of depolymerisation. Hence, no further equipment may be needed to get an initial idea of the degree of depolymerisation. The colour change might make it easier to get a precise measurement of the degree of depolymerisation if equipment is used and it may allow unconventional equipment to be used for the determination of the degree of depolymerisation, such as a spectrometer.

In some embodiments, the indicator is a pH indicator, a complexometric indicator, a redox indicator, a temperature indicator or a hydrolysis indicator.

In some embodiments, the indicator is a pH indicator, preferably a halochromic indicator. These indicators could, for instance, be used in polymers wherein due to depolymerisation, the acidity changes. This acidity change can be due to acid functionalities or base functionalities being formed by depolymerisation of the polymer. For example, many poly-condensates form —COO^{·} groups upon depolymerisation, which cause a change in acidity. pH indicators can be used to visualise these changes in acidity. Particularly, a pH indicator can be used in polycondensate polymers, preferably polyesters, for the indication of the degree of depolymerisation.

In some embodiments, the indicator is responsive to changes in concentrations of protons, in the polymer composition or the article.

In some embodiments, the equivalence point of the pH indicator lays between pH 2.0 and pH 12.0, preferably between pH 3.0 and pH 11.0, preferably between pH 4.0 and pH 10.0, preferably between pH 5.0 and pH 9.0, preferably between pH 6.0 and pH 8.0.

In some embodiments, the colour transition range of the indicator is below a pH of 7.00, preferably below a pH of 6.50, preferably below a pH of 6.00, preferably below a pH of 5.50. Especially for degradable polymers, which acidify during decomposition, are these indicators of interest.

In some embodiments, the pKa of the base, and/or the buffer agent is higher than the colour transition range of the indicator. Here again, this is particularly of interest for degradable polymers, which acidify during decomposition, the higher pKA of the base, results in first the neutralisation with the base occurs upon degradation, before the pH is lowered, and the indicator changes colour. This way, the moment of colour changes can be delayed, allowing for more degradation to occur before the colour change happens.

In some embodiments, the indicator is a natural or a synthetic indicator, preferably selected from the list comprising cresol red, methyl red, bromocresol purple, bromocresol green, chlorophenol, resazurin, bromothymol blue, xylenol, curcumin, alizarin, shikonin, betalain, flavonoid and anthocyanin or combinations thereof. Preferably, the indicator is a natural indicator.

In some embodiments, the indicator is resazurin, which is also known as 7-Hydroxy-3H-phenoxazin-3-one 10-oxide (=Structure (VI)). Resazurin has a blue to purple colour at pH>6.5, and because it can be irreversibly reduced to the pink-coloured and highly fluorescent resorufin (7-Hydroxy-3H-phenoxazin-3-one). At circum-neutral pH, resorufin can be detected by visual observation of its pink colour or by fluorimetry, with an excitation maximum at 530-570 nm and an emission maximum at 580-590 nm.

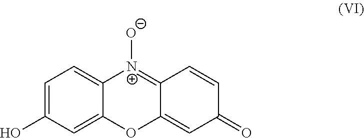 [SMILES: O=c1ccc2[n+]([O-])c3ccc(O)cc3oc-2c1]

In some embodiments, the indicator is an anthocyanin. As used herein, the term “anthocyanin” may refer to a flavonoid compound formed from glycosylated polyhydroxy or polymethoxy derivatives of 2-phenylchromen. It is a natural colorant that reflects light from red to blue in the visible spectrum depending on amongst other the pH.

In some embodiments, the indicator is curcumin a molecule that can be in the keto-form (structure VIIa) or the enol form (structure VIIb). In polar, acidic, and neutral conditions, the keto form is dominant, which is yellow; while in non-polar and alkaline conditions, especially at pH>8, the enol form is dominant, which is red.

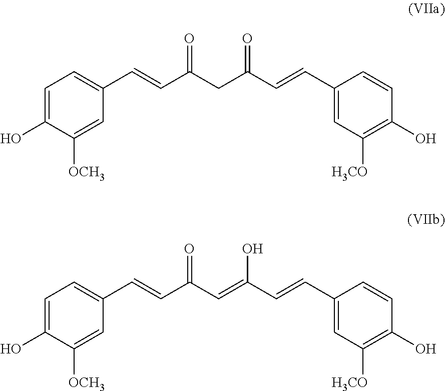 [SMILES: COc1cc(/C=C/C(=O)CC(=O)/C=C/c2ccc(O)c(OC)c2)ccc1O ; COc1cc(/C=C/C(=O)/C=C(O)/C=C/c2ccc(O)c(OC)c2)ccc1O]

Curcumin may also be used as a complexometric indicator for example for boron. Curcumin reacts with boric acid to form a red-coloured compound.

In some embodiments, the indicator is alizarin, which is also known as 1,2-dihydroxyanthraquinone, and may be represented by Structure (VIII). The colour of alizarin may change from yellow to purple upon pH conditions.

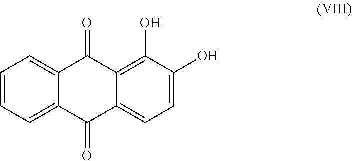 [SMILES: O=C1c2ccccc2C(=O)c2c1ccc(O)c2O]

In some embodiments, the indicator may be a betalain. As used herein the term “betalain” may be understood as a class of red and yellow tyrosine-derived pigments found in plants of the order Caryophyllales. There are two categories of betalains:
betacyanins, include the reddish to violet betalain pigments. Betanin, isobetanin, probetanin, and neobetanin are examples of betacyanins.
betaxanthins, including the yellowish to orange betalain pigments. Vulgaxanthin, miraxanthin, portulaxanthin, and indicaxanthin are examples of betaxanthins.

In some embodiments, the indicator may be betanin, which may be represented by structure (IX)

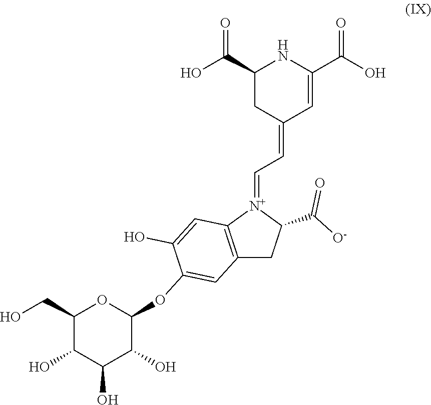 [SMILES: O=C(O)C1=C/C(=C/C=[N+]2/c3cc(O)c(O[C@@H]4O[C@H](CO)[C@@H](O)[C@H](O)[C@H]4O)cc3C[C@H]2C(=O)[O-])C[C@@H](C(=O)O)N1]

In some embodiments, the indicator may be Miraxanthin-II, which is an example of a miraxanthin. Miraxanthin-II may be represented by Structure (X).

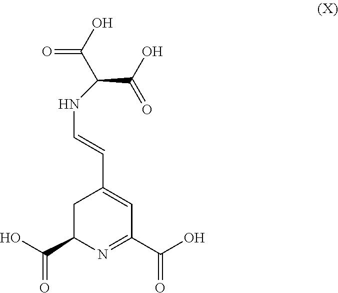

In some embodiments, the indicator may be shikonin, which may also be known as (±)-5,8-Dihydroxy-2-(1-hydroxy-4-methyl-3-pentenyl)-1,4-naphthoquinone. The colour of shikonin may change over a pH range from 2 to 12, starting from red at pH 2, over purple around pH 7 to blue at pH 12. Shikonin may be represented by Structure (XI).

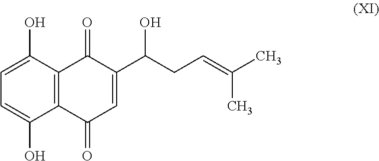 [SMILES: CC(C)=CCC(O)C1=CC(=O)c2c(O)ccc(O)c2C1=O]

In some embodiments, the indicator is a nitrophenyl ester or a derivative thereof, preferably a nitrophenyl acetate or a derivative thereof, preferably a p-nitrophenyl acetate, as represented by formula (XII), or a derivative thereof.

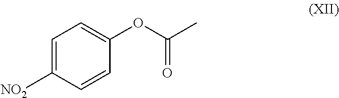

Upon hydrolysis of the ester the colorless p-nitrophenyl acetate (XII) changes to p-nitrophenol ((XIII) which has a yellow color.

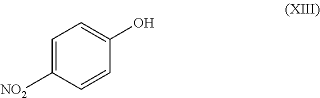

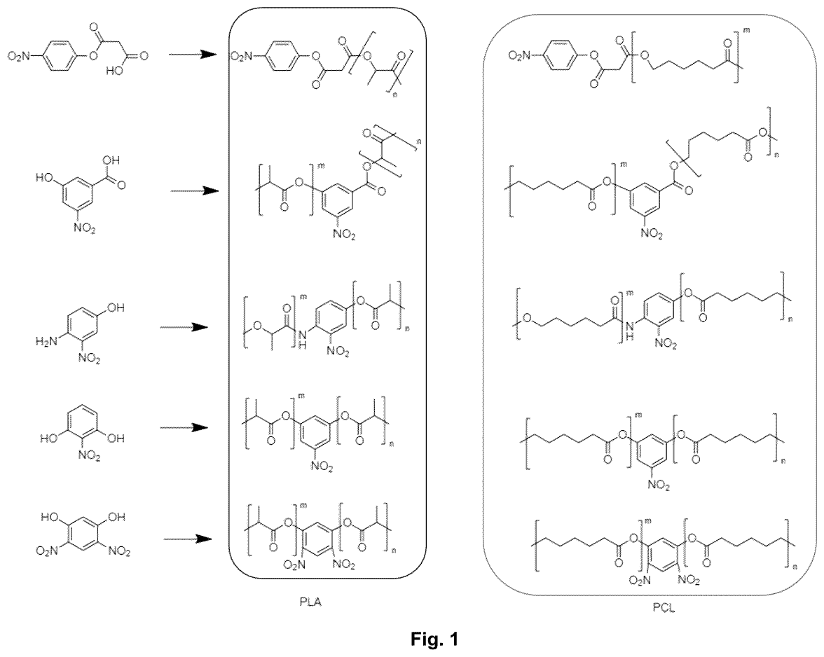

In particular nitrophenyl esters can be integrated into the backbone of polymers such as PLA and PCL. Examples of such integrations are given in FIG. 1 where the integration of respectively 4-(carboxyacetoxy)benzoic acid, 3-hydroxy-5-nitrobenzoic acid, 4-amino-3-nitrophenol, 2-nitrobenzene-1,3-diol and 4,6-dinitroresorcinol into PLA and PCL is shown. Upon degradation of the PLA or PCL polymer these compounds are released and provide a color change indicating the degree of degradation.

According to some embodiments of the present invention the indicator is responsive to changes in concentration of ions, temperature, redox potential, and/or hydrolytic conditions.

In some embodiments, the indicator is a complexometric indicator. Examples of such a complexometric indicators are:
Calcein and Patton-Reeder Indicator for calcium as analyte;
Curcumin for boron as analyte;
Eriochrome Black T for aluminium, cadmium, zinc, calcium or magnesium as analyte;
Fast Sulphon Black for copper as analyte.

In some embodiments, the polymer composition may comprise the complexometric indicator in a complex with their analyte. Upon degradation of the polymers, the complex may be come accessible for the environment and the environment may remove the analyte from the complex with the complexometric indicator, causing a change of appearance.

In some embodiments, the indicator is a redox indicator. Redox indicators could be used in hydrophobic polymers, where protons are indicated by degradation in a non-water environment. For example, methylene blue can be used as an indicator, where protons participate in the redox reaction, responsible for the change in colour.

In some embodiments, the indicator is a temperature indicator. In some embodiments, the polymer composition comprises a temperature indicator and a thermal radical initiator, such as azo-compounds and peroxided, for example Azobisisobutyronitrile (AIBN), 1,1′-Azobis(cyclohexanecarbonitrile) (ACHN), di-tert-butyl peroxide, benzoyl peroxide, methyl ethyl ketone peroxide. The thermal radical initiator would upon heating split into radicals, and these radicals could speed up degradation and depolymerisation. The change in appearance of the temperature indicator would indicate or mark that the heating of the polymer to initiate the radicals had already occurred, and that degradation is happening.

In some embodiments, the indicator is hydrolysis indicator. As used herein, the term “hydrolysis indicator” may refer to a compound that changes appearance when a bond is hydrolysed. Preferably, a hydrolysis indicator comprises an ester bond, an amide bond or a glycosidic bond; preferably an ester bond, which upon hydrolysis changes the appearance of the indicator. Examples of hydrolysis indicators are p-nitrophenyl acetate (sensitive to de-esterification), fluorescein diacetate (sensitive to de-esterification), and Resorufin β-D-glucuronide (sensitive to glycosidic cleavage).

In some embodiments, the indicator may be Resorufin β-D-glucuronide, which may be represented by structure (XV), which is orange. Upon cleavage of the glycosidic bond, resorufin (structure XVI) is released, which is bright pink. This indicator may be particular of interest to indicate the degree of depolymerisation in polysaccharide based polymers and polymer compositions.

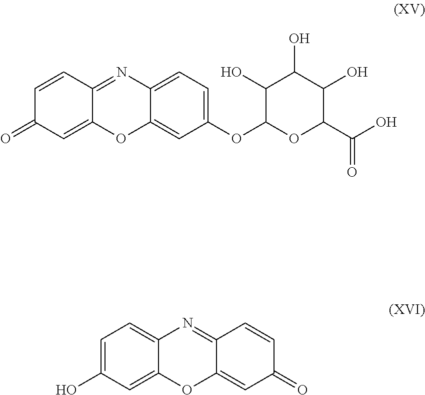 [SMILES: O=C(O)C1OC(Oc2ccc3nc4ccc(=O)cc-4oc3c2)C(O)C(O)C1O ; O=c1ccc2nc3ccc(O)cc3oc-2c1]

In some embodiments, the indicator may be fluorescein diacetate, which may be represented by structure (XVII), and which is collarless. Upon de-esterification, fluorescein is set free, which may be represented by structure (XVIII), which is green.

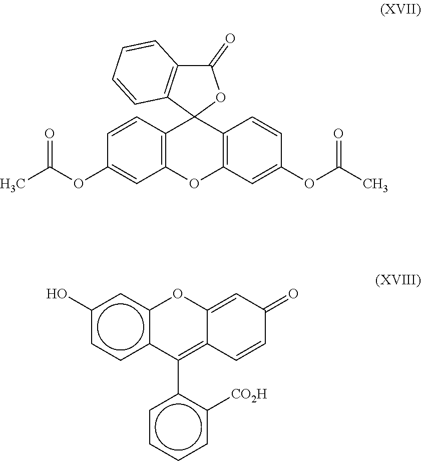

In some embodiment, the indicator is dye of which at least one hydroxyl functionality is esterified, preferably acetylated, and wherein cleavage of the ester bond causes a change is colour.

In some embodiments, the indicator is a halochromic indicator or an ionochromic indicator, preferably a halochromic indicator.

In some embodiments, the indicator is chemically blended or physically blended in the polymer composition.

As used herein, the term “chemical blending” is preferably understood as the process of making a blend of additives and polymers, oligomers or monomers, wherein the additives chemically react with the polymers, oligomers or monomers either during polymerisation or post polymerisation. The additive in the obtained chemical blend can therefore be build into the polymer backbone, be covalently bound to the side chains of the polymer, or be reacted with one or both ends of the polymer chain. The advantage of a chemical blend may be that the additive, or more particular the indicator, is chemically bound to the polymer, and therefor prevents leaching out of the additive from the polymer of polymer composition. In order to facilitate a chemical blend, reactive groups may need to be introduced to the initiators disclosed herein. For example, hydroxide groups, carboxylic groups or amine groups may be introduced to the initiators, allowing them to be incorporated in the polymers via esterification or amide bond formation.

As used herein, the term “physical blending” is preferably understood as the process of making a polymer blend by:
mechanically mixing polymers and additives together preferably in the melt phase of the polymers,
solution mixing.

The advantage of physical blending may be the ease of formation, as no reactive groups need to be present on the additive, which may be required for chemical blending.

In some embodiments, the indicator is chemically incorporated, preferably copolymerised, in the polymer composition; preferably chemically incorporated, preferably copolymerised, in the degradable polymer. The chemical incorporation makes it more difficult for the indicator to leach out.

Preferably,

In some embodiments, the indicator in incorporated in the polymer composition or the degradable polymer via at least one hydrolysable bond, and preferably, the indicator is a hydrolysis indicator, and even more preferably the degradable polymer is a poly-condensate, such as a polyester or a polyamide, preferably a polyester. When such a polymer would depolymerise for instance by a hydrolase, the hydrolysable bond connecting the hydrolysis indicator to the polymer can be broken, after which the hydrolysis indicator would change appearance, preferably colour.

In some embodiments, the degradable polymer is a polycondensation polymer, preferably a polyester, a polyamide, a polyimide, a polyacetal, a polyurethane, a polycarbonate, or randomized or block-copolymerized mixtures thereof; preferably, the degradable polymer is a polyester.

In some embodiments, the degradable polymer comprises ester, amide, acetal and/or urethane linkages.

In some embodiments, the degradable polymer is PLA, PCL or randomized or block-copolymerized mixtures thereof.

In some embodiments, the polymer composition comprises:
at least 0.01 wt. % to at most 10.00 wt. % of said indicator;
0.00 wt. % to a most 25.00 wt. % of a base, buffering agent or a mixture thereof, preferably a base; and,
at least 65.00 wt. % to at most 99.99% wt. % of said degradable polymer, preferably as defined herein.

The presence of the base can compensate the pH change caused by the initial polymer matrix and due to an allowable amount of depolymerisation. This way the degree of depolymerisation at which the appearance of the indicator, preferably the pH indicator, can be manipulated. This is for example useful for polymer compositions and articles which allow a certain amount of depolymerisation, before they lose a certain property or quality.

The invention may also provide in a polymer composition or an article comprising said polymer composition, preferably a self-indicating degradable polymer or a self-indicating degradable polymer composition, wherein the polymer composition comprises:
at least 0.01 wt. % to at most 10.00 wt. % of said indicator, preferably a hydrolysis indicator;
at least 0.00 wt. % to a most 25.00 wt. % of a base, buffering agent or a mixture thereof, preferably a base; and,
at least 65.00 wt. % to at most 99.99 wt. % of a degradable polymer, preferably as defined herein.

More specifically, the invention may also provide in a polymer composition or an article comprising said polymer composition, wherein the polymer composition comprises:
at least 0.01 wt. % to at most 10.00 wt. % of said indicator;
at least 0.05 wt. % to a most 25.00 wt. % of a base, buffering agent or a mixture thereof, preferably a base; and,
at least 65.00 wt. % to at most 99.94 wt. % of a degradable polymer, preferably as defined herein.

In some embodiments, the polymer composition or the degradable polymer comprises at least 0.01 wt. % to at most 10.00 wt. %, preferably at least 0.05 wt. % to at most 9.50 wt. %, preferably at least 0.10 wt. % to at most 9.00 wt. %, preferably at least 0.20 wt. % to at most 8.00 wt. %, preferably at least 0.50 wt. % to at most 7.00 wt. %, preferably at least 0.70 wt. % to at most 6.00 wt. %, preferably at least 1.00 wt. % to at most 5.00 wt. %, preferably at least 1.50 wt. % to at most 4.00 wt. %, preferably at least 2.00 wt. % to at most 3.00 wt. %, of said indicator.

In some embodiments, the polymer composition or the degradable polymer comprises at least 0.01 wt. %, preferably at least 0.05 wt. %, preferably at least 0.10 wt. %, preferably at least 0.20 wt. %, preferably at least 0.50 wt. %, preferably at least 0.70 wt. %, preferably at least 1.00 wt. %, preferably at least 1.50 wt. %, preferably at least 2.00 wt. %, of said indicator.

In some embodiments, the polymer composition comprises at least 0.10 wt. % to at most 25.00 wt. %, preferably at least 0.20 wt. % to at most 20.00 wt. %, preferably at least 0.50 wt. % to at most 15.00 wt. %, preferably at least 0.70 wt. % to at most 10.00 wt. %, preferably at least 1.00 wt. % to at most 7.00 wt. %, preferably at least 1.50 wt. % to at most 5.00 wt. %, preferably at least 2.00 wt. % to at most 3.00 wt. %, of a base, buffering agent or a mixture thereof, preferably a base.

In some embodiments, the polymer composition comprises at least 65.00 wt. % to at most 99.99 wt. %, preferably at least 67.00 wt. % to at most 99.95 wt. %, preferably at least 68.00 wt. % to at most 99.90 wt. %, preferably at least 70.00 wt. % to at most 99.00 wt. %, preferably at least 75.00 wt. % to at most 98.00 wt. %, preferably at least 80.00 wt. % to at most 95.00 wt. %, preferably at least 85.00 wt. % to at most 90.00 wt. %, of a degradable polymer, preferably as defined herein.

In some embodiments, the polymer composition comprises at least 65.00 wt. %, preferably at least 70.00 wt. %, preferably at least 75.00 wt. %, preferably at least 80.00 wt. %, preferably at least 85.00 wt. %, of a degradable polymer, preferably as defined herein.

In some embodiments, the base is selected from the list comprising NaOH, KOH, Ca(OH)₂, CsOH, RbOH, Mg(OH)₂, LiOH, Sr(OH)₂, Br(OH)₂, Na₂CO₃, NaHCO₃, NH₄OH, urea, histamine, or mixtures thereof, preferably selected from the list comprising NaOH Na₂CO₃, NaHCO₃, NH₄OH, urea, histamine or mixtures thereof. In some embodiments, the base is an inorganic base.

In some embodiment, the buffering agent is one of the Good's buffers, which comprises MES, ADA, PIPES, ACES, MOPSO, Cholamine chloride, MOPS, BES, TES, HEPES, DIPSO, TAPSO, acetamindoglycine, POPSO, HEPPSO, HEPPS, Tricine, Tris, Glycinamide, glycylglycine, Bicine, and TAPS.

The invention further comprises a method for visualizing depolymerisation in a polymer composition or an article comprising the polymer composition; comprising the steps of:
incorporating an indicator in the polymer composition, preferably to obtain a polymer composition as defined herein;
optionally, forming the article from the polymer composition.

In some embodiments, the method further comprises the step of incorporating a base in the polymer composition. Preferably the amount of base is depending on the initial pH of the fresh polymer matrix and optionally on the allowable amount of depolymerisation, before depolymerisation should be indicated by the indicator.

More particular, the invention provides in a method for visualizing depolymerisation in a polymer composition or an article comprising the polymer composition; comprising the steps of:
incorporating an indicator in the polymer composition, preferably in an amount from at least 0.01 wt. % to at most 10.00 wt. % compared to the total weight of the polymer composition;
incorporating a base, a buffer agent or a mixture of thereof in the polymer composition, preferably in an amount from at least 0.05 wt. % to a most 25.00 wt. % compared to the total weight of the polymer composition;
optionally, forming the article from the polymer composition.

As used herein, the term incorporating should preferably be understood as covering both physical blending and chemical blending.

The invention further provides in a self-indicating degradable polymer, wherein an indicator is chemically incorporated in or to a degradable polymer, preferably a biodegradable polymer.

In some embodiments of the self-indicating degrading polymer, is the indicator a hydrolysis indicator, which is chemically incorporated in or to the biodegradable polymer, via at least one ester bond or a amide bond, preferably an ester bond. The indicator may be incorporated into the polymer backbone, attached to a side chain or an end-cap of the polymer.

In some embodiment of the self-indicating degrading polymer may comprise a nitrophenyl-ester.

In some embodiments of the self-indicating degrading polymer, the degradable polymer is preferably a poly-condensate, more preferably a polymer selected from the list comprising polylactic acid (PLA), Polybutylene succinate (PBS), Polybutylene succinate terephthalate (PBST), Polybutylene adipate terephthalate (PBAT), Polycaprolactone (PCL), Polyhydroxyalkanoate (PHA), Polypropylene carbonate (PPC) or mixtures thereof.

In some embodiments of the self-indicating degrading polymer, the indicator to be chemically incorporated in or to the degrading polymer may be a compounds according to structures (I1) to (I5), as provided below.

In some embodiments, the self-indicating degrading polymer may be a polymer which can be represented by structure (PLA1) to (PLA5) or (PCL1) to (PCL5), as provided below.

It should be understood that certain embodiments of the use are also embodiments of the polymer composition, the method and the self-indicating degradable polymer, and vice-versa.

A further aspect of the invention may lay in one of any combination of the following numbered statements:
1. Use of an indicator, to indicate the degree of depolymerisation, preferably the degree of biodegradation, of a degradable polymer in a polymer composition or an article made from said polymer composition, preferably wherein appearance change of the indicator is caused by the depolymerisation of the degradable polymer;
   wherein the indicator is chemically incorporated, preferably copolymerised, in the polymer composition, and more preferably chemically incorporated in the degradable polymer.
2. The use according to statement 1, wherein said indicator is a chromatic indicator.
3. The use according to statement 1 or 2, wherein the indicator is a pH indicator, a complexometric indicator, a redox indicator, a temperature indicator or a hydrolysis indicator.
4. The use according to any of statements 1 to 3, wherein the indicator is a halochromic indicator or an ionochromic indicator, preferably a halochromic indicator.
5. The use according to any of statements 1 to 4, wherein the colour transition range of the indicator is below a pH of 7.00, preferably below a pH of 6.50, preferably below a pH of 6.00, preferably below a pH of 5.50.
6. The use according to any of statements 1 to 5, wherein the degradable polymer is a biodegradable polymer, preferably a home-compostable polymer.
7. The use according to any of statements 1 to 6, wherein the polymer is a polycondensation polymer, preferably a polyester, a polyamide, a polyimide, a polyacetal, a polyurethane, a polycarbonate, or mixtures thereof; preferably the polymer is a polyester.
8. The use according to any of statements 1 to 7, wherein the indicator is responsive to changes in concentrations of protons, in the polymer composition or the article made from said polymer composition.
9. The use according to any of statements 1 to 8, wherein the indicator is a natural or a synthetic indicator, preferably selected from the list comprising cresol red, methyl red, bromocresol purple, bromocresol green, chlorophenol, resazurin, bromothymol blue, xylenol, curcumin, alizarin, shikonin, betalain, flavonoid and anthocyanin and/or derivatives, preferably co-polymerizable derivatives, thereof.
10. The use according to any of statements 1 to 9, wherein the indicator is responsive to changes in concentration of ions, temperature, redox potential, and/or hydrolytic conditions.
11. A polymer composition or an article comprising said polymer composition, wherein the polymer composition comprises:
   at least 0.05 wt. % to a most 25.00 wt. % of a buffering agent; and,
   at least 75.00 wt. % to at most 99.95 wt. % of a degradable polymer,
   wherein the degradable polymer comprises an indicator, suitable for indicating the degree of depolymerisation, preferably suitable for indicating the degree of biodegradation; wherein the indicator is chemically incorporated, preferably copolymerised, in the polymer composition, and more preferably chemically incorporated in the degradable polymer.
12. The polymer composition according to statement 11, wherein at least 0.01 wt. % to at most 10.00 wt. % of the indicator, is chemically incorporated in the degradable polymer, wherein the weight % is expressed compared to the total weight of the polymer composition.
13. A method for visualizing depolymerisation in a polymer composition or an article comprising the polymer composition, wherein the polymer composition comprises a degradable polymer, preferably a biodegradable polymer;
   wherein the method comprises the steps of:
      chemically incorporating, preferably copolymerizing, an indicator in the polymer composition, preferably the degradable polymer;
      optionally, forming the article from the polymer composition.
14. A self-indicating degradable polymer, wherein an indicator is chemically incorporated in or to a degradable polymer, preferably a biodegradable polymer.
15. The self-indicating degradable polymer according to statement 14, wherein the indicator is a hydrolysis indicator and wherein the degradable polymer is a poly-condensate, preferably a polyester or a polyamide, more preferably a polyester.
16. Use of an indicator, to indicate the degree of depolymerisation, preferably the degree of biodegradation, of a degradable polymer in a polymer composition or an article made from said polymer composition, preferably wherein appearance change of the indicator is caused by the depolymerisation of the degradable polymer.
17. The use according to statement 16, wherein said indicator is a chromatic indicator.
18. The use according to statement 16 or 2, wherein the indicator is a pH indicator, a complexometric indicator, a redox indicator, a temperature indicator or a hydrolysis indicator.
19. The use according to any of statements 16 to 3, wherein the indicator is chemically blended or physically blended in the polymer composition.
20. The use according to any of statements 16 to 4, wherein the indicator is chemically incorporated, preferably copolymerised, in the polymer composition and more preferably in the degradable polymer.
21. The use according to any of statements 16 to 5, wherein the indicator is a halochromic indicator or an ionochromic indicator, preferably a halochromic indicator.
22. The use according to any of statements 16 to 6, wherein the degradable polymer is a biodegradable polymer, preferably a home-compostable polymer.
23. The use according to any of statements 16 to 7, wherein the polymer is a polycondensation polymer, preferably a polyester, a polyamide, a polyimide, a polyacetal, a polyurethane, a polycarbonate, or mixtures thereof; preferably the polymer is a polyester.
24. The use according to any of statements 16 to 8, wherein the indicator is responsive to changes in concentrations of protons, in the polymer composition or the article made from said polymer composition.
25. The use according to any of statements 16 to 9, wherein the indicator is a natural or a synthetic indicator, preferably selected from the list comprising cresol red, methyl red, bromocresol purple, bromocresol green, chlorophenol, resazurin, bromothymol blue, xylenol, curcumin, alizarin, shikonin, betalain, flavonoid and anthocyanin or combinations thereof.
26. The use according to any of statements 16 to 8, wherein the indicator is responsive to changes in concentration of ions, temperature, redox potential, and/or hydrolytic conditions.
27. A polymer composition or an article comprising said polymer composition, wherein the polymer composition comprises:
   at least 0.01 wt. % to at most 10.00 wt. % of an indicator, indicating the degree of depolymerisation, preferably the degree of biodegradation;
   at least 0.05 wt. % to a most 25.00 wt. % of a buffering agent; and,
   at least 65.00 wt. % to at most 99.99 wt. % of a degradable polymer.
28. A method for visualizing depolymerisation in a polymer composition or an article comprising the polymer composition; comprising the steps of:
   incorporating an indicator in the polymer composition;
   optionally, forming the article from the polymer composition.
29. A self-indicating degradable polymer, wherein an indicator is chemically incorporated in or to a degradable polymer, preferably a biodegradable polymer.
30. The self-indicating degradable polymer according to statement 29, wherein the indicator is a hydrolysis indicator and wherein the degradable polymer is a poly-condensate, preferably a polyester or a polyamide, more preferably a polyester.

### EXAMPLES

### Example 1

In this example several indicator derivatives (I1-I5) are disclosed which may be chemically blended into PLA or PCL, thereby forming the corresponding PLA1-PLA5 or PCL1-PCL5. The indicator derivatives (I1-I5) are derived from p-nitrophenyl acetate (=structure (XII)), which is colourless when the acetate group is present and yellow after hydrolysis of the ester binding, thereby removing the acetate group and forming p-nitrophenol (=structure (XIII), which is yellow.

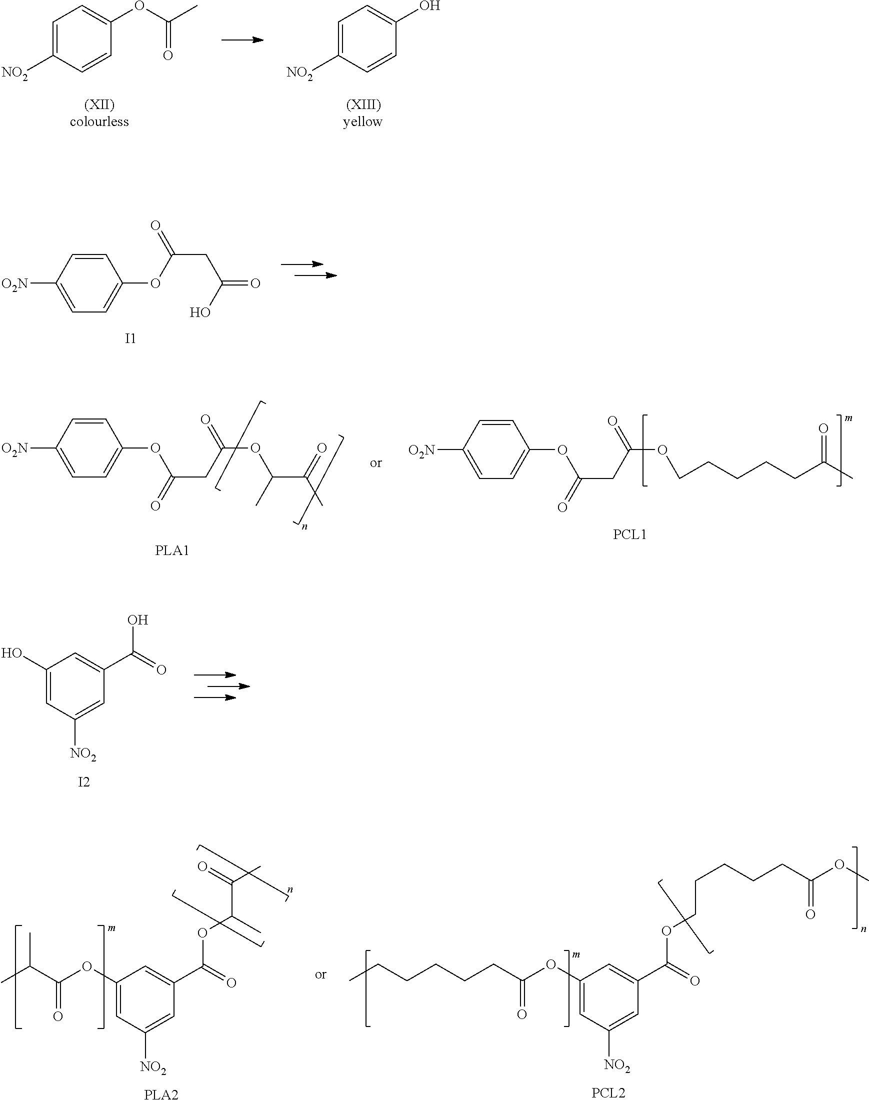

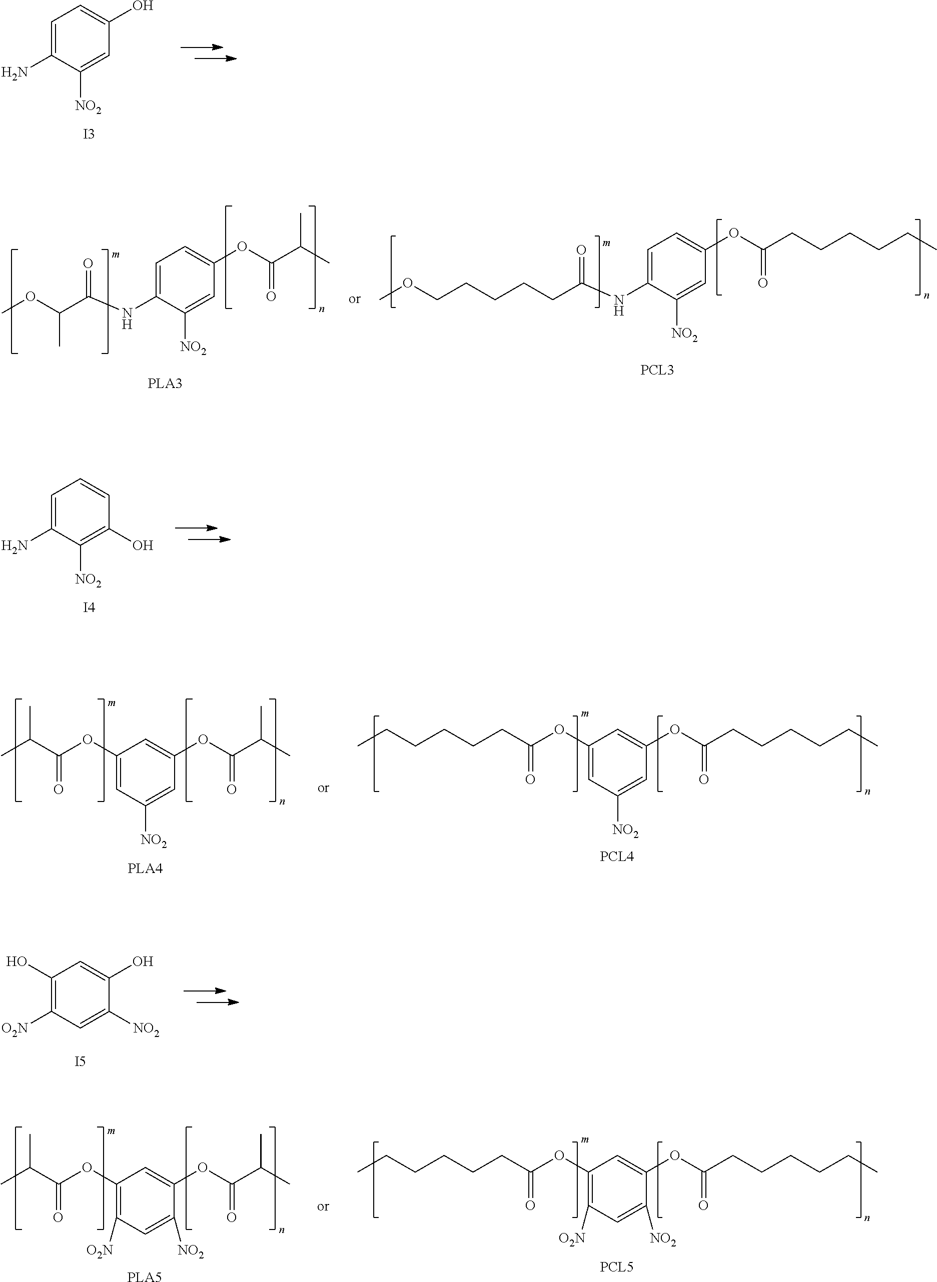

In PLA1 and PCL1, the indicator 11 is chemically incorporated in the polymer as an end-cap, via esterification. In PLA2-PLA5 and in PCL2-PCL5, the respective indicator I2-I5 is chemically incorporated into the backbone of the polymer, via esterification for I2, I4 and I5 or via esterification and amide bond formation for 13.

As these polymers PLA1-PLA5 or PCL1-PCL5 are degraded and depolymerise by hydrolysis of the ester bonds in the polymer backbone, hydrolysis of the ester bond next to the nitrophenyl moiety in the polymer backbone, will cause the colour change from colourless to yellow, which indicates the depolymerisation of the degradable polymers PLA1-PLA5 or PCL1-PCL5.

### Example 2

BromoCresol Green (BCG) (=structure XIV) may act as a pH indicator or halochromic indicator, as the compound is:
Yellow, at a pH below pH 3.8;
Green, at a pH between pH 3.8 and 5.4; and
Blue, at a pH above pH5.4

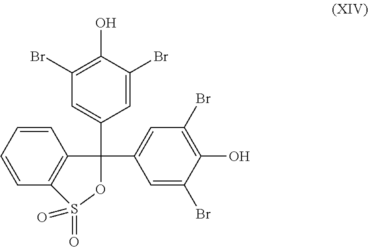 [SMILES: O=S1(=O)OC(c2cc(Br)c(O)c(Br)c2)(c2cc(Br)c(O)c(Br)c2)c2ccccc21]

BromoCresol Green was extruded into PCLCAPA 6250 from Ingevity, in an amount of 1 wt %, together with 1.00 wt % NaOH; in a Filafab extruder at 120° C. with a residence time of about 3 minutes. The color of the extruded filament was blue.

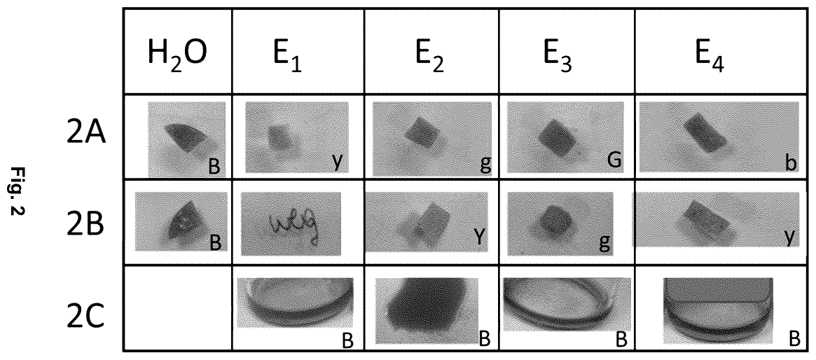

The extruded filament was chopped into 5 different pieces, of which four pieces were subjected to enzymatic digestion, each with another enzyme. The fifth piece of filament was used as a control experiment only using water and no enzyme, but being subjected to the same conditions as the other pieces during the enzymatic digestion. As a negative control, four aliquots of silica powder, comprising 1 wt % BromoCresol Green and 1.00 wt % NaOH, was also subjected to the enzymatic digestion, with the four different enzymes. The results can be seen in FIG. 2:
wherein in row 2A the filament pieces are shown after 12 hours enzymatic digestion at 40° C.;
wherein in row 2B the same filament pieces are shown as in row 2A after an additional 48 hours enzymatic digestion at 37° C.;
wherein row 2C shows the negative controls which underwent the same enzymatic digestion, wherein silica powder is used in stead of the degradable polymer.

As FIG. 2 is provided in black and white, it should be noted that the in reality, the colour changes from blue (B=bright blue, b=pale blue), over green (G=bright green, g=pale green) to yellow (Y=bright yellow, y=pale yellow). The entry where “weg” is written, is Dutch for “gone”, and means that the complete filament is digested.

### Example 3

BromoCresol Green was extruded into PLA Ingeo™ 6302D from NatureWorks®, in an amount of 2 wt %, together with 1.00 wt % NaOH; in a TRUUS extruder at 140° C. with a residence time of about 2.5 minutes. The colour of the extruded powder was blue, which switched yellow in an aqueous solution with a pH of 4.

### Example 4

BromoCresol Green was extruded into PBS in an amount of 4 wt %, together with 1.00 wt % Na₂CO₃; in a TRUUS extruder at 140° C. with a residence time of about 2.5 minutes. The colour of the extruded pieces was blue, which switched yellow in an aqueous solution with a pH of 4.

What is claimed is:

1-15. (canceled)

16. An article comprising a polymer composition, wherein the polymer composition comprises:
at least 0.01 wt. % to at most 10.00 wt. % of an indicator, indicating the degree of depolymerisation, or the degree of biodegradation;
at least 0.05 wt. % to a most 25.00 wt. % of a base, a buffering agent or a mixture of thereof; and
at least 65.00 wt. % to at most 99.94 wt. % of a degradable polymer;
wherein the pKa of the base, and/or the buffer agent is higher than the colour transition range of the indicator.

17. The article according to claim 16, wherein the polymer composition comprises at least 0.05 wt. % to at most 25.00 wt. % of a base.

18. The article according to claim 16, wherein the base is selected from the list comprising NaOH, KOH, Ca(OH)₂, CsOH, RbOH, Mg(OH)₂, LiOH, Sr(OH)₂, Br(OH)₂, Na₂CO₃, NaHCO₃, NH₄OH, urea, histamine, or mixtures thereof, optionally selected from NaOH Na₂CO₃, NaHCO₃, NH₄OH, urea, histamine or mixtures thereof.

19. The article according to claim 16, wherein the base is an inorganic base.

20. The article according to claim 16, wherein the indicator is a chromatic indicator.

21. The article according to claim 16, wherein the indicator is a pH indicator, or a halochromic indicator.

22. The article according to claim 16, wherein the indicator is a natural or a synthetic indicator, optionally selected from the list comprising cresol red, methyl red, bromocresol purple, bromocresol green, chlorophenol, resazurin, bromothymol blue, xylenol, curcumin, alizarin, shikonin, betalain, flavonoid and anthocyanin or combinations thereof.

23. The article according to claim 16, wherein the colour transition range of the indicator is below a pH of 7.00, or below a pH of 6.50, or below a pH of 6.00, or below a pH of 5.50.

24. The article according to claim 16, wherein the indicator is chemically blended or physically blended in the polymer composition.

25. The article according to claim 16, wherein the indicator is chemically incorporated, or copolymerised, in the polymer composition, and optionally in the degradable polymer.

26. The article according to claim 16, wherein the degradable polymer is a biodegradable polymer, or a home-compostable polymer.

27. The article according to claim 16, wherein the polymer is a polycondensation polymer, optionally wherein the polymer is a polyester, a polyamide, a polyimide, a polyacetal, a polyurethane, a polycarbonate, or mixtures thereof; or the polymer is a polyester.

28. A method for visualizing depolymerisation in an article comprising a polymer composition; comprising the steps of:
incorporating an indicator in the polymer composition in an amount from at least 0.01 wt. % to at most 10.00 wt. % compared to the total weight of the polymer composition; and
incorporating a base, in the polymer composition in an amount from at least 0.05 wt. % to a most 25.00 wt. % compared to the total weight of the polymer composition;
wherein the pKa of the base, and/or the buffer agent is higher than the colour transition range of the indicator; and, forming the article from the polymer composition.

29. The method according to claim 28, wherein the base, the buffering agent or the mixture thereof are incorporated in the polymer composition by chemically blending or physically blending, or by extrusion.
